(19) United States
(12) Patent Application Publication
(10) Pub. No.: US 2010/0036999 A1
(43) Pub. Date: Feb. 11, 2010

(54) NOVEL METHOD OF FLASH MEMORY CONNECTION TOPOLOGY IN A SOLID STATE DRIVE TO IMPROVE THE DRIVE PERFORMANCE AND CAPACITY

(76) Inventors: Zhiqing Zhuang, Irvine, CA (US); Ming Huang, Oak Park, CA (US)

Correspondence Address: Zhiqing Zhuang, 35 Mount Vernon, Irvine, CA, 92620, US

(21) Appl. No.: 12/185,828

(22) Filed: Aug. 5, 2008

(51) Int. Cl. G06F 12/02

(52) U.S. Cl. 711/103; 711/E12.008

(57) ABSTRACT

The present invention provides a novel flash memory connection method between a flash controller and flash devices such that the controller can manage two or more flash devices concurrently. It provides the ability to efficiently manage a large array of non-volatile flash devices in a solid state drive (SSD) and allocate flash memory usage in such a way that at least doubles the SSD bandwidth and the total storage capacity.

### BACKGROUND OF THE INVENTION

1. Field of the Invention

This invention relates to the non-volatile memory storage system, and more particularly to the management of a large array of non-volatile memory devices in a solid state drive (SSD) to improve the drive performance and increase the drive capacity.

2. Description of Related Art

Recently, non-volatile solid state memory such as flash memory has gained popularity for use in replacing mass storage units in various technology areas such as computers, digital cameras, modems and the like. In such applications, usually only one or a small amount of flash devices are needed.

Solid state drives (SSDs) are devices that use exclusively non-volatile flash memory to store digital data. The two primary advantages resulting from using flash memory components instead of mechanical devices to store data are higher ruggedness and significantly improved performance in terms of random access speed, power consumption, and extended operating temperature range.

However, the capacity of a single flash device (about a few Gbytes) is still far less than the capacity offered by a mechanical based hard drive (a few hundreds Gbytes). Thus a SSD must be built from a large array of flash devices in order for it to be useful as a replacement of mechanical hard drive.

Although the SSD (throughput around 100 Mbytes per second) is already much faster than mechanical drive, it is still far from sustaining a storage interface such as fiber channel (200/400 Mbytes per second), serial ATA (150/300 Mbytes per second), or serial attached SCSI (300/600 Mbytes per second). Besides the speed limitation the flash read and write across the flash interface (around 25 MByte per second), there are also limitation with flash architecture. An inherent characteristic of flash memory is that it must be erased and verified for successful erasure prior to being programmed. Write and erase cycles are generally slow and can significantly reduce the performance of a system.

Flash memory is organized as a number of pages, where a page is a flash read/write unit, and a number of blocks, where a block is an erase unit. The write and erase of flash blocks are limited to a finite number of erase-write cycles, which basically determines the lifetime of the device. A flash management system usually implements a wear-leveling technique that spreads the write across entire flash memory blocks so the flash memory's lifespan is maximized by avoiding the excessive erases/writes to a small portion of entire available spaces.

Flash memory may have blocks permanently damaged and can not be used to store data after it is manufactured. And some blocks may become bad during the life time of a flash device. So bad block management is required in a flash management system.

There is therefore a need within SSD to efficiently manage a large array of flash devices to provide increased system performance, disk capacity, improved reliability and longevity.

A flash management system is taught by the authors in the pending U.S. Pat. No. 60/875,328. It provides a non-volatile flash memory management system and methods that provide the ability to efficiently manage a large array of flash devices and allocate flash memory usage in a way that improves reliability and longevity, while maintaining excellent performance. The invention mainly comprises of a processor, an array of flash memories that are modularly organized, an array of module flash controllers and a buffer memory. The accesses to flash array are paralleled in macro level, e.g., all flash entities are accessed (read or write) concurrently. However, if the flash memory data bus for each module is examined, the data are transferred serially on this bus. The data are transferred to bank 0 first. Upon finishing the data transfer to bank 0, data are transferred to bank 1, and so on. The data transfer performance is limited by this shared bus for each module.

Flash memory vendors manufacture the devices with either 8 bit or 16 bit wide data bus. To support both variations, the flash memory controllers are typically designed to support 16 bit data bus. There is a desire to use 8 bit devices in a SSD to increase the drive capacity. It thus results that half of data buses are wasted by connecting the 8 bit flash devices to 16 bit flash controller. The controller itself is not cost effective either.

There are a numerous of prior arts that manage the flash memories as described in section [0009] and [0010]. While these flash memory systems are useful, a more effective flash memory system is desired to improve the flash read and write performance and drive capacity.

### DISCLOSURE OF THE INVENTION

The present invention provides a flash memory connection method that provides the ability to efficiently manage a large array of non-volatile flash devices with 8 bit data bus and allocate flash memory usage in a way that doubles the SSD bandwidth and the total drive capacity.

The present invention is typically used in a flash memory management system comprise of a processor, one or more host interfaces, a buffer memory, an array of flash controllers with 16 bit data bus each, and a large array of flash memories with 8 bit data bus each.

The large array of flash memories are organized into modules and banks. Each flash controller controls one module, and each module is comprised of a number of banks selectable through chip selects, and each bank consists of two physical flash devices. This novel bank connection topology with two flash memories brings the performance and capacity advantages in a SSD drive. The connection topology has the following characteristics.

Control bus from flash controller is connected to both flash entities. So both devices will receive the same command, addresses, and data transfer strobes. The device ready busy signals from both devices are feed to controller to determine the device status.

After the same command is issued to both flash devices, the controller will wait both devices to be ready before declaring that the commands is completed for write, or starting the retrieval of read data from devices.

Each 16 bit data from flash controller are split into even and odd bytes, with even byes connected to flash device 0 and odd byes to flash device 1. The 16 bit data bus of flash controller is fully utilized.

The total drive capacity is doubled since upper 8 bits are utilized with one flash device, v.s., upper 8 bits are unconnected in prior arts.

The drive read/write performance is doubled since each transfer with flash carries 2 bytes of data, v.s. 1 byte if only one flash device is connected

The flash erase block size and read/write page size are doubled since two flash devices are always paired together. It thus has the implication to the embedded software to manage this topology correctly.

It should be understood that the controller data bus width 16 and memory data bus width 8 are just one example of present invention. As long as the controller data bus width is an integer multiple of memory data bus width, the data bus split arrangement can be done this way to fully utilize the flash controller data bus width and increase the total memory capacity.

It should also be understood that the “flash memory” in present invention refers to any type of non-volatile memory that has similar nature to the NAND flash, such as NOR Flash, Ovonic Universal Memory (OUM), and Magnetoresistive RAM (MRAM).

### BRIEF DESCRIPTION OF THE DRAWINGS

The preferred exemplary embodiment of the present invention will hereinafter be described in conjunction with the appended drawings, where like designations denote like elements, and:

FIG. 1 shows a prior art of the organization of a large array of flash memories; and

FIG. 2 shows a prior art how the 16 bit controller is connected to a 16 bit flash memory; and

FIG. 3 shows a prior art how the 16 bit controller is connected to a 8 bit flash memory; and

FIG. 4 shows, in the present invention, how the 16 bit controller is connected to two 8 bit flash memories.

FIG. 5 generalizes the present invention how the flash controller with data bus width N*w is connected to N instances of w bit flash memories.

### DETAILED DESCRIPTION

The present invention provides a novel method of flash memory connection topology in a SSD with increased system performance and storage capacity.

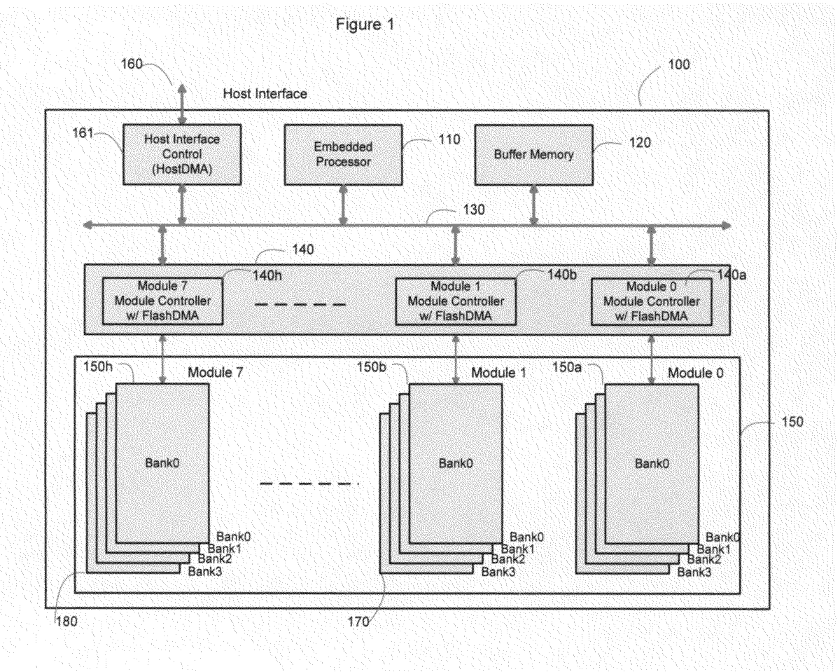

FIG. 1 shows a prior art storage device that can best be used in describing where the present invention can be applied.

The device utilizes a large array of flash memories. The exemplary storage device 100 includes an embedded processor 110, a host interface 160 and a host interface controller 161, a buffer memory 120, an internal bus 130, an array of flash module controllers 140, and an array of flash memories 150. The number of module controllers and the number of flash memories in each module are system dependent configuration.

The embedded processor 110 performs the computation and control function of the storage device 100. In particular, the processor 110 receives the storage command from host interface 160, and decodes and serves the command. In order to fulfill the host command, the processor 110 controls how and when the data are moved between flash memory array 150 and buffer memory 120 using FlashDMA engines inside module controllers 140a through 140h, and between buffer memory 120 and host interface 160 using HostDMA inside Host Interface Control 161 for the best system performance.

Flash controllers 140 comprise of a number of module controller 140a through 140h. Each module controller with its FlashDMA controls a flash module (150a or 150b or . . . or 150h) that comprises of a number of physical flash banks. In this prior art, each flash bank is a single physical flash device. The module controller DMA transfers data to/from each flash device by asserting active chip-select signal to the corresponding device. The flash device allows the chip-select to be de-asserted while data transfer is done but device is still busy in programming, erasing or preparing the read data. Thus, the data transfers to all flash devices can be pipelined on the module controller data bus.

Flash vendors manufacture flash memory devices with either 8 bit or 16 bit data bus. To support both variations, the flash memory controllers are typically designed to support 16 bit data bus. There is a desire to use 8 bit devices in a SSD to increase the drive capacity. It thus results that half of data buses are wasted by connecting the 8 bit flash devices to 16 bit flash controller. The controller itself is not cost effective, and the drive capacity is not maximized.

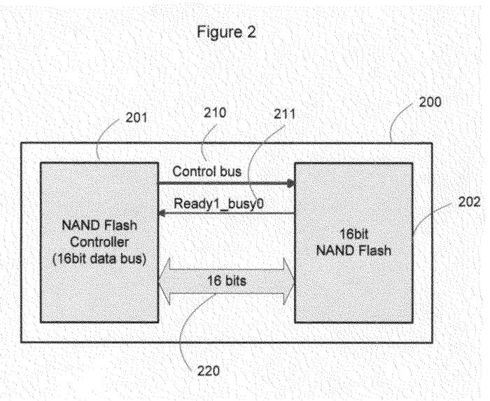

To better describe the present invention, the connection between the flash controller and the flash memory is further examined in FIGS. 2, 3 and 4.

FIG. 2 shows the prior art that a flash controller 201 with 16 bit data bus 220 is directly connected to 16 bit flash device 202. Control bus 210 carries the command and access address information to the device 202 and ready1_busy0 signal 211 feedbacks the flash device status back to controller 201.

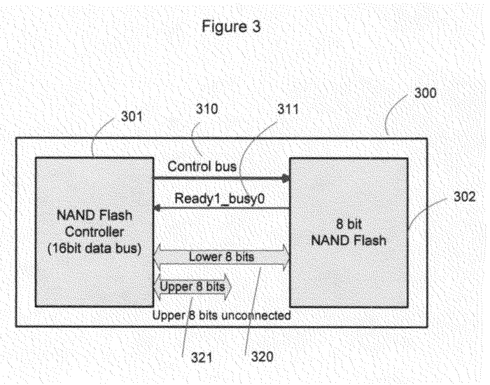

FIG. 3 shows the prior art that a flash controller 301 with 16 bit data bus is directly connected to 8 bit flash device 302 using only lower 8 bits of controller data bus 320, and upper 8 bits of the controller data bus 321 is not connected. Each flash device's capacity is limited by the technology used in fabricating it, independent of bus width. It is therefore FIGS. 2 and 3 have the same storage capacity assuming same technology is used.

The downsides of the connection topology in FIG. 3 are (1) half of the data path in flash controller is not utilized, and it results that the flash controller is not cost effective for this topology. (2) the data path bandwidth is reduced to half since each transfer can only carry 8 bits that is half of what the controller capable of.

The connection topology in FIG. 2 utilize full data path width of flash controller but drive capacity is not maximized as described in section [0032].

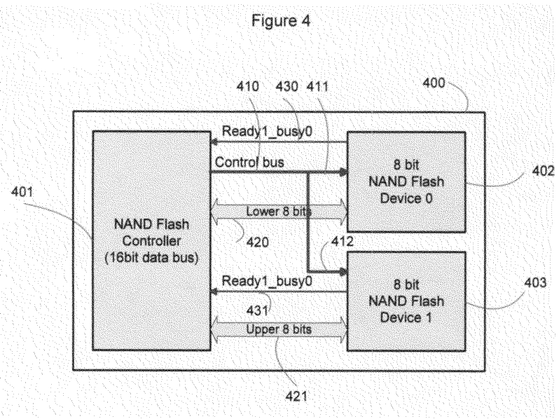

FIG. 4 shows how the present invention connects the 16 bit controller 401 to two 8 bit flash devices 402 and 403. The control bus 410 from flash controller carries command and access addresses to the control bus 411 of the flash device 0 402 and also to the control bus 412 of the flash device 1 403. Thus, flash device 402 and 403 receive the same command and access addresses, and both devices will carry the command issued by the flash controller 401.

The 16 bit data bus is split into lower 8 bits 420 and upper 8 bits 421, while the lower 8 bits are connected to the flash device 0 and upper 8 bits to flash device 1. When the issued command through 411 is a write command, even bytes from 16 bit flash data bus will be stored in flash device 0 through bus 420 and odd bytes in flash device 1 through bus 421. And, when the issued command is a read command, the even bytes will be read from flash device 0 through bus 420 and odd bytes from flash device 1 through bus 421.

However, even the same command is issued to both flash device 0 and 1 at the same time, device 0 and 1 are not necessary to complete the commands at the same time. Flash device 0 and 1 can report the different status at the same time. The device status can be carried on 8 bit data bus 420 and 421 to flash controller, or a simple busy indication by the ready1_busy0 signal 430 and 431.

The prior art controller 401 is designed to read device status only through lower 8 bits of data bus 420, and only need to process one read1_busy0 signal. With the present invention, the controller 401 is designed to be capable of read device 0 status using lower 8 bits of data bus 420, and device 1 status using upper 8 bits of data bus 421. The controller 401 also needs to be able to read ready1_busy0 status from both devices. Only when both devices complete the command, the controller can finish the command execution.

In present invention as shown in FIG. 4, the total drive capacity is doubled since upper 8 bits are utilized with one flash device, v.s., upper 8 bits are unconnected, or only one flash device with 16 bit data bus in prior arts.

The drive read/write performance is doubled since each transfer with flash carries 2 bytes of data, v.s., upper 8 bits are unconnected as in FIG. 3.

The flash erase block size and read/write page size are doubled since two flash devices are always paired together. It thus has the implication to the embedded software to manage this topology correctly.

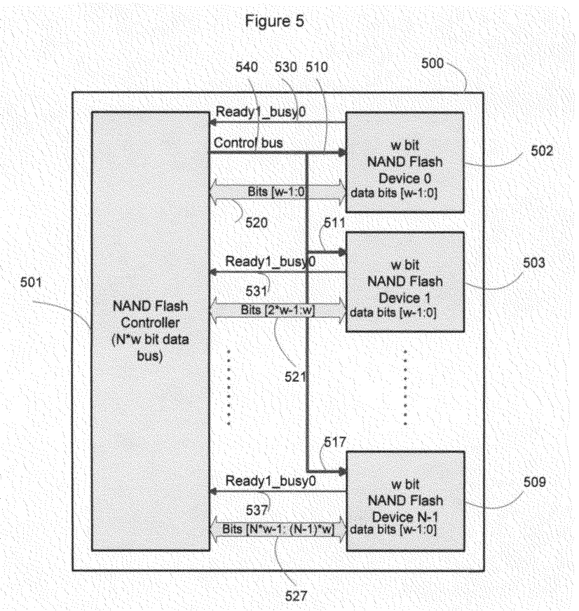

FIG. 5 generalizes the present invention to the case that the flash controller's data bus width N*w is an integer multiple of flash device's bus width w.

The control bus 540 from flash controller carries command and access addresses to the control bus 510, 511, . . . , 517 of the flash device 0, 1, . . . , 7. Thus, all flash devices 502, 503, . . . , 509 receive the same command and access addresses.

The N*w bit data bus from controller is split into N segments, and

Flash controller's data bus bits [w−1 down to 0] are connected to flash 0 bits [w−1 down to 0];
Flash controller's data bus bits [2*w−1 down to w] are connected to flash 1 bits [w−1 down to 0];

### And so on . . .

Flash controller's data bus bits [N*w−1 down to (N−1)w] are connected to flash N−1 bits [w−1 down to 0].

However, even the same command is issued to all flash devices at the same time, the devices are not necessary to complete the commands at the same time. The device statuses are carried back to the controller on their corresponding bus segment.

The prior art controller 501 is designed to read device status only through lower 8 bits of data bus 420. With the present invention, the controller 501 is designed to be capable of read device status using its corresponding bus segment. Only when all devices complete the command, the controller can finish the command execution.

In present invention as shown in FIG. 5, the total drive capacity is increased by a factor of N, v.s., only lowest w bits are unconnected, or only one flash device with N*w bit data bus in prior arts.

The drive read/write performance is increased by a factor of N since each transfer with flash carries N*w bits of data, v.s., only lowest w bits are transferred.

The flash erase block size and read/write page size are increased by a factor of N since N flash devices are always grouped together. It thus has the implication to the embedded software to manage this topology correctly.

FIG. 5 also generalizes the topology of a flash controller design with internal data bus width of N*w bits and using a common set of control bus.

What is claimed is:

1. A method of connecting flash memory controller with flash memory device that improves the flash based solid state drive's performance and capacity, wherein a solid state drive comprises of:
A embedded processor; and
A host interface; and
A buffer memory; and
An array of flash controllers with N*w bit data bus each; and
An array of flash devices with w bit data bus each.

2. The apparatus of claim 1 wherein the flash controllers and flash devices are organized into modules and banks, and the flash management system is scalable with the number of modules and the number of banks in each module.

3. The apparatus of claim 1 wherein each flash controller controls one module; and each module comprises of a number of banks selectable through chip selects; and a bank consists of N physical flash entities, enumerated from N−1 down to 0.

4. The apparatus of claim 1 wherein the flash controller's data bus width, N*w, enumerated from N*w−1 down to 0, is an integer multiple of flash device's data bus width w, enumerated from w−1 down to 0, such that:
Flash controller's data bus bits [w−1 down to 0] are connected to flash 0 bits [w−1 down to 0];
Flash controller's data bus bits [2*w−1 down to w] are connected to flash 1 bits [w−1 down to 0];
And so on . . .
Flash controller's data bus bits [N*w−1 down to (N−1)w] are connected to flash N−1 bits [w−1 down to 0].

5. The apparatus of claim 1 wherein the flash controller is able to issue the same control data including command, access addresses and read/write strobes to N flash devices in the same bank simultaneously.

6. The apparatus of claim 1 wherein the flash controller is able to read:
Flash 0's status from controller data bus bits [w−1 down to 0];
Flash 1's status from controller data bus bits [2*w−1 down to w];
And so on . . .
Flash N−1's status from controller data bus bits [N*w−1 down to (N−1)*w].

7. The apparatus of claim 1 wherein the “flash memory” refers to any type of non-volatile memory that has similar nature to the NAND flash, such as NOR Flash, Ovonic Universal Memory (OUM), and Magnetoresistive RAM (MRAM).
